(19) United States
(12) Patent Application Publication
(10) Pub. No.: US 2008/0106653 A1
(43) Pub. Date: May 8, 2008

(54) Spatial Light Modulator Techniques for Stage Lighting

(76) Inventor: Scott C. Harris, Rancho Santa Fe, CA (US)

Correspondence Address: Law Office of Scott C Harris, PO Box 1389, Rancho Santa Fe, CA, 92067, US

(21) Appl. No.: 11/557,066

(22) Filed: Nov. 6, 2006

(51) Int. Cl. H04N 9/31

(52) U.S. Cl. 348/744; 348/E09.025

(57) ABSTRACT

Spatial light modulator techniques for stage lighting. A first technique pieces together multiple spatial light modulator's or sectors within an existing spatial light modulator to form an overall area which is closer to being square. For example, to 16×9 spatial light modulators may be located next to one another to form, in effect, a 16×18 spatial light modulator. The same thing can be done within sectors of the spatial light modulator. New forms for the spatial light modulator are also disclosed including a ferroelectric liquid Crystal. The spatial light modulators can receive computer-generated holograms to form three-dimensional representations that are projected from a stage light.

### BACKGROUND

Stage lighting often includes projecting high-intensity beams of light in specified shapes, colors and with specified effects, onto a stage. The basic perimeter shape of such a beam is typically circular, although “gobos” can be used to shape the outer circumference of the shape to any desired single or multiple shape.

Pixel-level controllable gobos have been implemented, including the so-called digital light. Digital lights use spatial light modulators such as digital mirror devices or grating light valves to control the projection of the light. These allow both video to be produced, but also allow shaping the outer perimeter of the beam.

### SUMMARY

The present application describes an improved digital light device and method, using a spatial light modulator technique which allows new effects.

### BRIEF DESCRIPTION OF THE DRAWINGS

FIG. 1 is an illustration showing a light producing a light beam;

FIG. 2 is a flowchart showing how the controller controls the spatial light modulators;

FIG. 3 illustrates an embodiment where each spatial light modulator has its own light source;

FIG. 4 illustrates an embodiment where a single spatial light modulator is logically divided into the first and second parts; and

FIG. 5 shows an embodiment with a computer generated hologram.

### DETAILED DESCRIPTION

The general structure and techniques, and more specific embodiments which can be used to effect different ways of carrying out the more general goals, are described herein.

According to one embodiment, two or more separate spatial light modulators are used to form different parts of a single projected beam.

Digitally controlled spatial light modulators have recently found application for use in television applications. Accordingly, the chip manufacturers have tended to optimize the packaging and aspect ratio of the spatial light modulators for use in television.

Unfortunately for the stage lighting industry, television has evolved towards screens with wider aspect ratios. The 4:3 aspect ratio of the 80's has evolved into a 16:9 aspect ratio, or even wider aspect ratios. Projection of light in a stage lighting environment, however, more often makes use of symmetrical perimeters such as circles and triangles. This means, therefore, that only a fraction of the rectangular aspect ratio chip has been used.

Square or circular chips would be ideal for stage lighting, but the chip manufacturers are unlikely to make them in the future. Therefore only a very small part of the chip can be used.

According to the present embodiment, the overall light beam to be modified and/or shaped by the spatial light modulator (“SLM”) is divided. The divided light beam is then shaped, and pieced back together. By dividing the light beam, the rectangular aspect ratio of the spatial light modulator can be used as a slice of the overall beam. The light beam is pieced together in slices edge to edge. Edge blending techniques are used on the edges of the pieced image to allow an edge blended image to be formed from two separate SLM's. For example, 2 16×9 SLM's can be used to each project half of a display—for an effective size of 16×18.

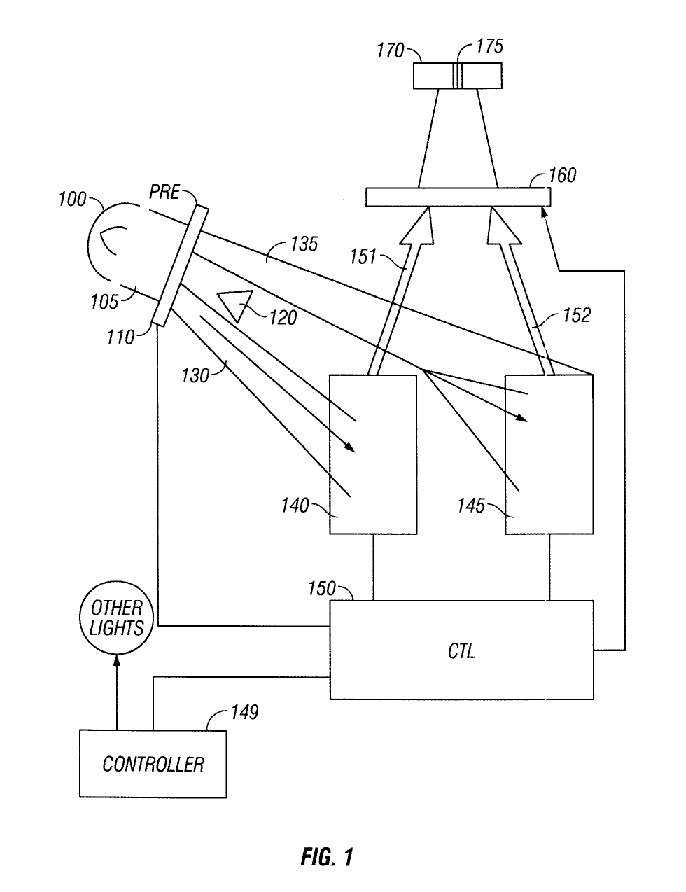

FIG. 1 shows a first embodiment in which a light 100 produces a light beam 105. In the embodiment, the system may be used in stage lighting, and therefore the light may be between 100 and 900 W, more preferably at least 300 W in illumination. The light beam 105 is first modified by preprocessing optical system 110. The preprocessing optical system 110 may include a dichroic system which rejects certain parts of the infrared, and may also include certain kinds of coloration parts. In the embodiment, the entire light beam may be uniformly colored even though that uniformly colored light beam is being sent to multiple different spatial light modulators. The light beam is divided at 120 into a first light path 130 and a second light path 135. 120 may simply be a prism or mirror assembly that divides the beam into two laterally divided beams. The beam 130 is sent to a first spatial light modulator 140, and the beam 135 is sent to a second spatial light modulator 145. According to the embodiment, the spatial light modulators may be mirror devices or DMD's. Alternatively, the spatial light modulators can be other devices, such as liquid crystals, ferroelectric liquid crystals, or other similar devices. Ferroelectric liquid crystals may be particularly interesting, because of their ability to switch light quickly and in interesting ways.

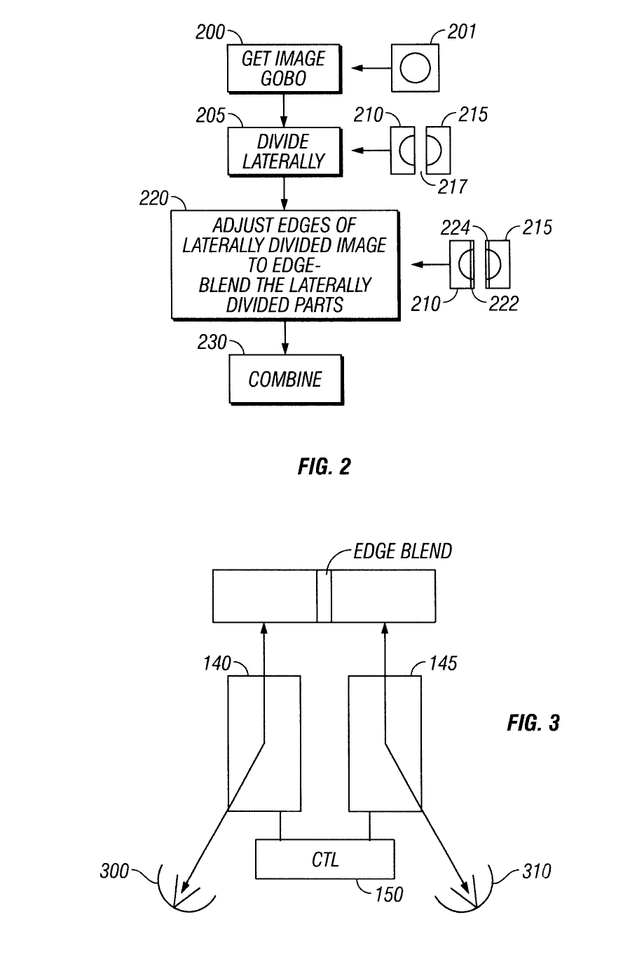

Both of the spatial light modulators 140, 145 are connected to and controlled by a controller 150. Controller 150 controls the spatial light modulators according to the flowchart of FIG. 2. The controller 150 may itself be controlled by a central controller 149, that also controls other lights. According to this flowchart, an image is divided laterally into two parts, with a dividing point of the image corresponding to a dividing point between the two parts of the two spatial light modulators. Of course, more than two SLM's may be used, e.g., 3 or 4. It may be preferred that the SLM's form as close to a square as possible when laterally pieced together. Since different parts of the image are controlled by different parts of the spatial light modulator, an edge blending effect is also carried out to edge blend the pieces image.

At 200, the image or gobo which is going to be used by the spatial light modulators is obtained. This image or gobo may be a circle, or may be any desired shape. 201 shows this image as being a circle. This may be any shape, preferably a shape other than a rectangle. The image is divided laterally at 205, so that the image is formed into two sub image parts with a dividing line between the two parts. This is shown in 205 as the left image part 210, and right image part 215 with the dividing line between the two parts as 217. At 220, the images of the laterally divided images are edge blended. For example, the image part 210 has its edge 222 blended with the edge 224 of the other part 215. These parts may be blended to be slightly overlapped, or to remove edge effects, using any known image blending technique. The edge blending changes the images in a way such that the images 210 and 215 can be displayed directly next to one another and look like a single image. Technology for modifying positions of the images in this way are well-known, for example, used in multiple DMD based devices. At 230, the images are then combined.

Note that both the images from the spatial light modulators 140 and 145 correspond to different parts of the same image at the same time. This compares with other multiple spatial light modulator devices where each spatial light modulator handles a separate part of the image, produced at different times, which are averaged together by persistence of vision.

The image output 151 from light modulator 140 and the image output 152 from light modulator 145 form the two parts of the projected beam. Post optics 160 receive these projected beams, and may color the beam, and may also include lensing and other elements to more precisely register the two beam parts with one another. The output of the optics is the beam itself shown as 170, which is an overall image as shaped by the two image parts, with an edge blended portion 175 as its pieced-together central portion.

Different modifications of this basic concept are also contemplated. FIG. 3 illustrates an embodiment where each spatial light modulator 140, 145 has its own light source, 200, 210 respectively associated therewith. This may allow more brightness out of the device, at a cost of more power consumption and a heavier and larger device.

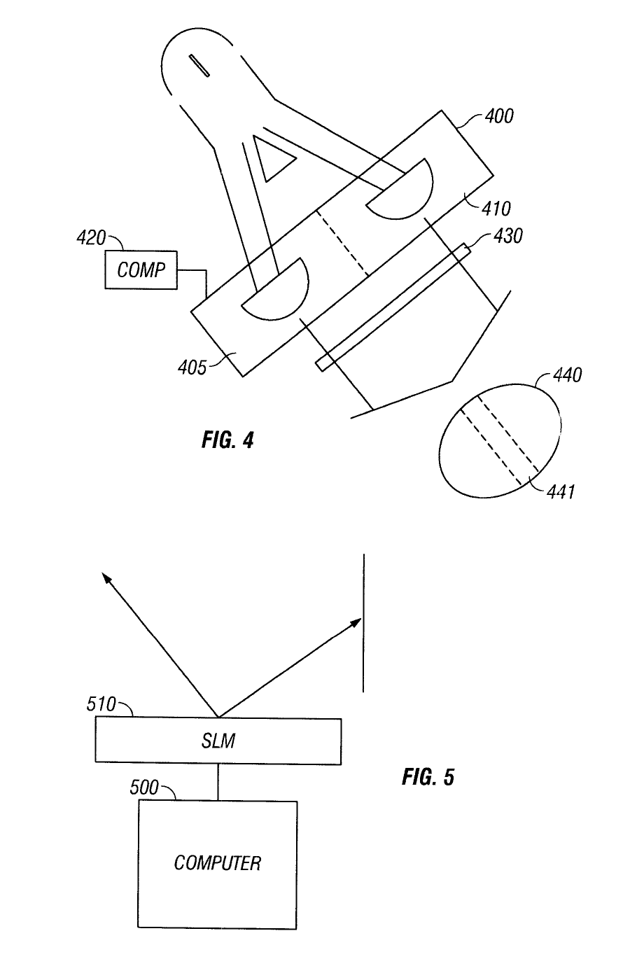

FIG. 4 illustrates an alternative embodiment, in which a single spatial light modulator 400 is logically divided into the first and second parts 405, 410. Each of the parts corresponds to a division which is in a direction which tends to preserve more symmetry in the geometry of the spatial light modulator 400. In this embodiment, the computer 420 divides the overall image into its two halves, and feeds those two halves respectively to portions of the single spatial light modulator. The light beam is shaped in this way, later processed by optics 430, and used to form the final shape image 440. As in the other embodiments, the area of overlap between the two partial images shown as 441, is edge blended by the computer operation. Also, as in the other embodiments, the image may be divided into more than 2 parts, e.g., 3 or 4 parts

According to another embodiment shown in FIG. 5, the spatial light modulator, such as a DMD or other device, is controlled by a computer 500 in order to form a computer-generated hologram. Computer-generated holography uses interference and diffraction to record and reconstruct optical waveforms, and may be used to manipulate light in ways that are not possible using pure lens and mirror systems. For example, the computer-generated holograph can be used to synthesize a three-dimensional image that has stereoscopic displays, and use that to form a hologram on the spatial light modulator 510 which is used for projection of an image. Grayscale images from the spatial light modulator can be formed from binary fringe patterns. This embodiment may also divide the images into multiple parts and edge blend them, as in the embodiments of FIGS. 1-4. This embodiment also may gobo the outer shape, so that the outer shape is something other than a rectangle.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other divisions and other SLM's are possible.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A method, comprising:
obtaining an electronic file representative of a display to be displayed by a stage lighting device;
determining parts of the electronic file which represent parts of the display which are divided along a dividing line, to define divided display parts;
edge blending at least a portion of an edge of at least one of said divided display parts; and
using said divided image parts to control a beam of light to be displayed.

2. A method as in claim 1, wherein said using comprises applying said divided image parts each to a respective spatial light modulator.

3. A method as in claim 1, wherein said using comprises applying said divided image parts to different parts of the same spatial light modulator.

4. A method as in claim 1, wherein said using comprises using said divided image parts to shape an outer perimeter of portions of a stage light beam, and to subsequently combine said portions.

5. A method as in claim 1, wherein said display is a two-dimensional image with a shaped outer perimeter that has a shape that is other than a rectangle.

6. A method as in claim 1, wherein said display represents a three-dimensional image represented by a hologram.

7. A method, comprising:
obtaining an electronic file representative of a three-dimensional display that has an outer perimeter that is other than a rectangle, to be projected by a stage lighting device; and
using said electronic file to drive an element to form the three-dimensional display to be displayed.

8. A method as in claim 7, wherein said element is a pixel level controllable on-off device.

9. A method as in claim 7, wherein said element is a polarization controllable device.

10. A lighting system, comprising:
a control part that receives an electronic file indicative of a display that is to be used to project light, that defines first and second parts indicative of a divided display with a dividing line between the parts of the divided display, and which controls edge blending of at least one of said parts, and produces outputs indicative thereof.

11. A lighting system as in claim 10, further comprising a lamp device, having a power of at least 400 W, producing light along an optical axis, and a spatial light modulator assembly, along said optical axis, driven by said outputs.

12. A lighting system as in claim 11, wherein said spatial light modulator assembly includes first and second spatial light modulators.

13. A system as in claim 12, wherein the divided display is divided substantially in half along a lateral line passing through the entire display.

14. A system as in claim 12, wherein said divided display is divided substantially in thirds along two lateral lines passing through the entire display.

15. A system as in claim 12, wherein there is only a single spatial light modulator, receiving said output.

16. A system as in claim 15, further comprising a light producing part, forming an optical path for light, and wherein said spatial light modulator assembly is located along said optical path.

17. A system as in claim 16, wherein there is only a single spatial light modulator, receiving said divided display in different sections thereof.

18. A system as in claim 16, wherein there are multiple spatial light modulators, each receiving part of the divided display.

19. A system has in claim 16, wherein said spatial light modulator assembly includes pixel level controllable digital devices that can be controlled between on and off states.

20. A system as in claim 19, wherein said spatial light modulators are digital mirror devices.

21. A system as in claim 16, wherein said spatial light modulator assembly includes polarization controllable devices.

22. A system as in claim 21, wherein said spatial light modulator assembly includes a ferroelectric liquid crystal.

23. A system as in claim 12, wherein said display produces a two-dimensional image.

24. A system as in claim 12, wherein said display produces a three-dimensional image.

25. A lighting system, comprising:
a control part that obtains an electronic file indicative of a three-dimensional optical scene and produces a computer-generated hologram based on said three-dimensional optical scene, and produces an electronic output signal indicative of the three-dimensional hologram; and
an interface to a stage lighting device, receiving said electronic output signal and producing an output based thereon.

26. A lighting system as in claim 25, wherein said interface to a stage lighting device produces an optical output based on said output signal.

27. A lighting system as in claim 25, wherein said control part changes an outer perimeter of said hologram to be a shape other than rectangular.
